(19) United States
(12) Patent Application Publication
(10) Pub. No.: US 2003/0086114 A1
(43) Pub. Date: May 8, 2003

(54) Identifying printing devices based on attributes of information to be printed

(76) Inventors: Darrel D. Cherry, Meridian, ID (US); James Clough, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/008,480

(22) Filed: Nov. 5, 2001

(51) Int. Cl. B41J 1/00; G06F 15/00

(52) U.S. Cl. 358/1.15

(57) ABSTRACT

Systems and methods for printing information are provided. A representative method for printing information includes: receiving information corresponding to a user's intent to print a print task; identifying at least one printing device possessing capabilities corresponding to attributes of the print task so that the at least one printing device is able to print the print task optimally compared to at least another unidentified printing device; enabling the user to select from among the at least one printing device identified; and facilitating printing of the print task at the selected printing device to produce a printed document, the printed document exhibiting the attributes of the print task. Systems and other methods also are provided.

### FIELD OF THE INVENTION

The present invention generally relates to printing. In particular, the present invention relates to systems and methods for printing that are adapted to identify printing devices that can be used to print a document based, at least in part, on attributes of information that is to be printed.

### DESCRIPTION OF THE RELATED ART

Mobile appliances, such as personal digital assistants (PDAs) and messaging-enabled phones, are becoming quite commonplace. Such devices can perform numerous time-saving functions and can be used to receive information from and/or transmit information to various devices. By way of example, a user can operate a mobile appliance so that email messages sent to the user's email address, which may be associated with a local area network (LAN), can be forwarded to the user via the mobile appliance. Thus, the user can have access to email messages in virtual disregard of the user's location.

Remote printing also can be facilitated by a mobile appliance. In particular, a user can use a mobile appliance to direct information that is to be printed to a printer located remote from the user's LAN. This can enable the user to be unencumbered by printed documents until the printed documents are required for use. At that time, the user can operate the mobile appliance to direct a print task corresponding to the required documents to a printer located in the vicinity of the user.

As is known, however, not all printers exhibit the same performance characteristics. For instance, some printers do not include the requisite memory or specialized print mechanisms for producing detailed graphical images. Additionally, not all printers are capable of producing color images. Therefore, when the user directs a print task to a printer, such as via a mobile appliance, and the printer to which the information is directed does not support all of the characteristics of the information, the printed document provided by the printer may be of a lower quality than that desired by the user.

Based on the foregoing, it should be appreciated that there is a need for improved systems and methods that address these and/or other shortcomings of the prior art.

### SUMMARY OF THE INVENTION

The present invention involves the identification of printing devices that can be used to print a document based, at least in part, on attributes of information that is to be printed. In this regard, a representative embodiment of a method of the invention includes: receiving information corresponding to a user's intent to print a print task; identifying at least one printing device possessing capabilities corresponding to attributes of the print task so that each of the printing devices identified is able to print the print task optimally as compared to at least some unidentified printing devices; enabling the user to select from among the identified printing devices; and facilitating printing of the print task at the selected printing device to produce a printed document, the printed document exhibiting the attributes of the print task.

Another representative embodiment of a method for printing information includes: receiving information corresponding to printing devices; storing the information corresponding to the printing devices; receiving, via a communication network, information corresponding to a user's intent to print a print task, analyzing information corresponding to the print task to identify at least one attribute of the print task; identifying a printing device possessing capabilities corresponding to the at least one attribute of the print task such that the printing device is able to print the print task optimally compared to at least another unidentified printing device; providing the user with information corresponding to the printing device identified via a communication network; enabling the user to select the printing device for printing the print task; and facilitating printing of the print task at the printing device selected to produce a printed document such that the printed document exhibits the attributes of the print task.

A representative embodiment of a system of the invention includes a print request processing system that is configured to communicatively couple with a communication network. The print request processing system also is configured to receive information corresponding to a user's intent to print a print task and identify one or more printing devices. Preferably, each of the identified printing devices possesses capabilities corresponding to attributes of the print task so that each of the printing devices is able to print the print task optimally, as compared to at least some unidentified printing devices. The print request processing system is further configured to provide information corresponding to the identified printing devices to the user via a communication network as well as provide information corresponding to the print task to a selected one of the printing devices via a communication network. In this manner, a printed document can be produced by the printing device that exhibits the attributes of the print task.

Another representative embodiment of a system of the invention includes a mobile appliance. The mobile appliance incorporates a print request system, a user input component, a display device, and an RF transmitter/receiver. The RF transmitter/receiver is configured to communicatively couple with a communication network. The print request system is configured to receive, via the user input component, information corresponding to a user's intent to print a print task. The print request system also is configured to receive, via the RF transmitter/receiver, information corresponding to at least one printing device. Preferably, the at least one printing device possesses capabilities corresponding to attributes of the print task. The at least one printing device can be displayed to the user via the display device so that the user is able to select from among the at least one printing device identified. Additionally, the print request system can provide information corresponding to the selected printing device to the communication network via the RF transmitter/receiver.

### BRIEF DESCRIPTION OF THE DRAWINGS

The present invention, as defined in the claims, can be better understood with reference to the following drawings. The drawings are not necessarily to scale, emphasis instead being placed on clearly illustrating the principles of the present invention.

FIG. 1 is a schematic diagram depicting a representative embodiment of the print system of the present invention.

FIG. 2 is a flowchart depicting functionality of the print system of FIG. 1.

FIG. 3 is a schematic diagram depicting a computer or processor-based system that can be used to implement the print request processing system of FIG. 1.

FIG. 4 is a flowchart depicting functionality of a representative embodiment of the print request processing system of FIG. 3.

FIG. 5 is a flowchart depicting functionality of a representative embodiment of the print analysis system of FIG. 3.

FIG. 6 is a flowchart depicting functionality of a representative embodiment of the printer selection system of FIG. 3.

FIG. 7 is a flowchart depicting functionality of a representative embodiment of print device selection system of FIG. 3.

FIG. 8 is a flowchart depicting functionality of a representative embodiment of the print request system of FIG. 3.

### DETAILED DESCRIPTION

Print systems of the present invention can potentially alleviate some of the difficulty experienced by users when attempting to print their documents at a site that is remote from their computer or computer network. As described in greater detail herein, embodiments of the print system can accomplish this by identifying one or more printing devices, e.g., printers, multi-function devices, etc., that are capable of processing the user's print task. Embodiments of the print system then can enable the user to select from among the identified printing devices so that the print task can be performed by the selected printing device. Typically, the identified printing devices are capable of printing the information in a manner that more closely corresponds to the attributes of the print task. In this manner, quality of the printed documents can be optimized compared to using another printing device, e.g., a printing device that may be known, but is not recommended for use in printing the print task.

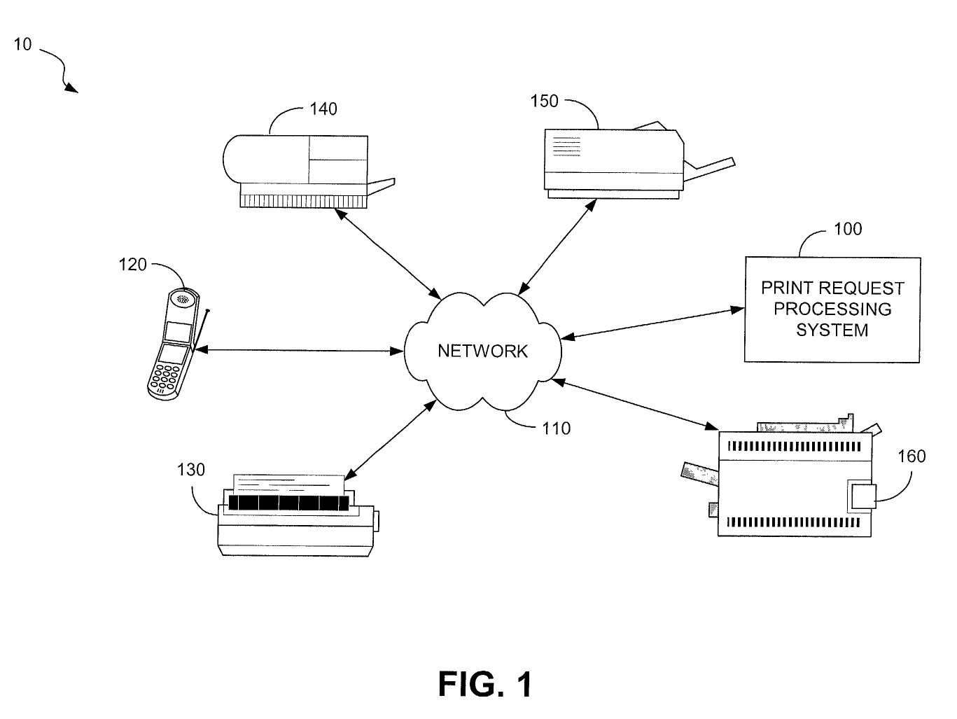

Referring now to the drawings, wherein like reference numerals indicate corresponding components throughout the several views, FIG. 1 is a schematic diagram depicting an embodiment of a print system 10 of the present invention. As shown in FIG. 1, print system 10 includes a print request processing system 100 that is configured to communicate with a user via a network 110. By way of example, a user can communicate with print request processing system 100 via a mobile appliance 120, such as small form factor device, e.g., a phone, PDA, etc., or laptop, among others. In other embodiments, a computer or processor-based device that is not configured as a mobile appliance can be used to communicate with the print request processing system. Network 1 10 also enables communication with one or more printing devices, such as printers 130 through 160. As used herein, the term “printing device” refers to a device or a combination of devices capable of producing hardcopy, e.g., a document, corresponding to information provided in a digital format.

Network 110 may be any type of communication network employing any network topology, transmission medium, or network protocol. For example, network 160 may be any public or private packet-switched or other data network, including the Internet, circuit-switched networks, such as the public switched telephone network (PSTN), wireless network, or any other desired communications infrastructure and/or combination of infrastructures.

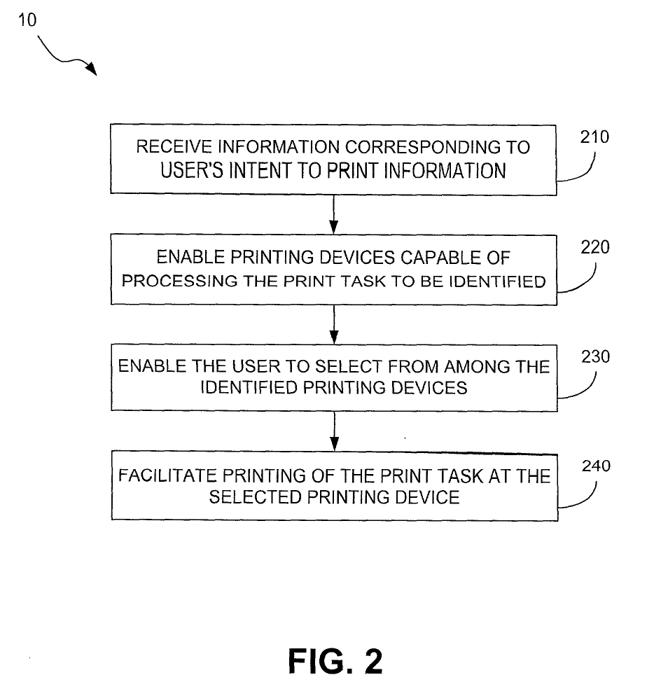

Representative functionality of the print system of FIG. 1 will now be described with reference to the flowchart of FIG. 2. As shown in FIG. 2, print system or method 10 may be construed as beginning at block 210, where a request for a user's intent to print information to hardcopy is received. In block 220, the identification of one or more printing devices capable of processing the print task associated with the user's request is enabled. Thereafter, such as depicted in block 230, the user is enabled to select from the identified printing devices. In block 240, printing of the print task at the selected printing device is facilitated.

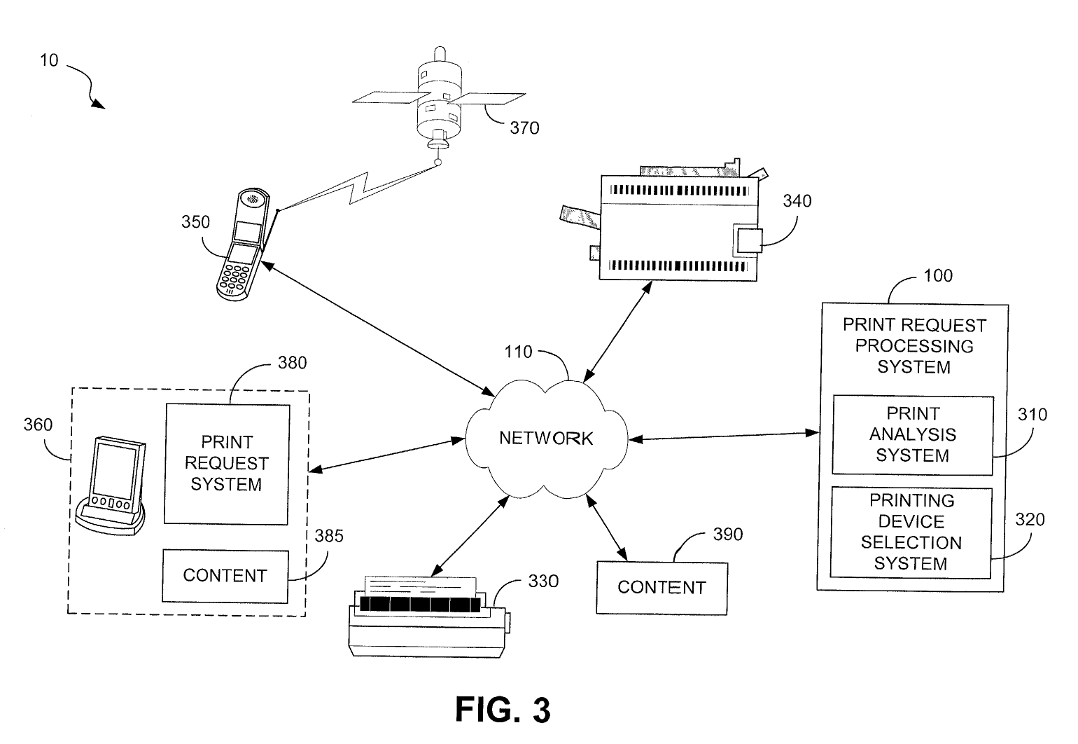

Another embodiment of print system 10 is depicted in FIG. 3. In FIG. 3, print system 10 includes a print request processing system 100 that includes a print analysis system 310 and a printing device selection system 320. Similar to that described in FIG. 1, the print system of FIG. 3 is configured to communicate with a user via a network 110, which also enables communication with one or more printing devices, such as printers 330 and 340.

A user can communicate with print request processing system 100 via a mobile appliance, such as phone 350 or personal digital assistant 360, for example. Such a mobile appliance can include a locating device, e.g., a Global Positioning System (GPS) receiver, that can be used to determine the location of the mobile appliance. In FIG. 3, a GPS satellite 370 is depicted providing information to mobile appliance 350. As will be described later, information corresponding to the location of the mobile appliance can be used by the print request processing system to identify printing devices from which the user can select for performing a printing function.

In some embodiments, determining the location of the mobile appliance can be advantageous, but other techniques can be used for providing a user with information regarding printing devices. For instance, the print request processing system or an associated memory device could store information corresponding to printing devices typically used by the user. Based on an analysis of the information to be printed, a printing device could be selected from among these printing devices. In other embodiments, information about the user's location still could be used to identify a suitable printing device for the user, such as by using both information corresponding to the user's location as well as information corresponding to pre-selected printing devices.

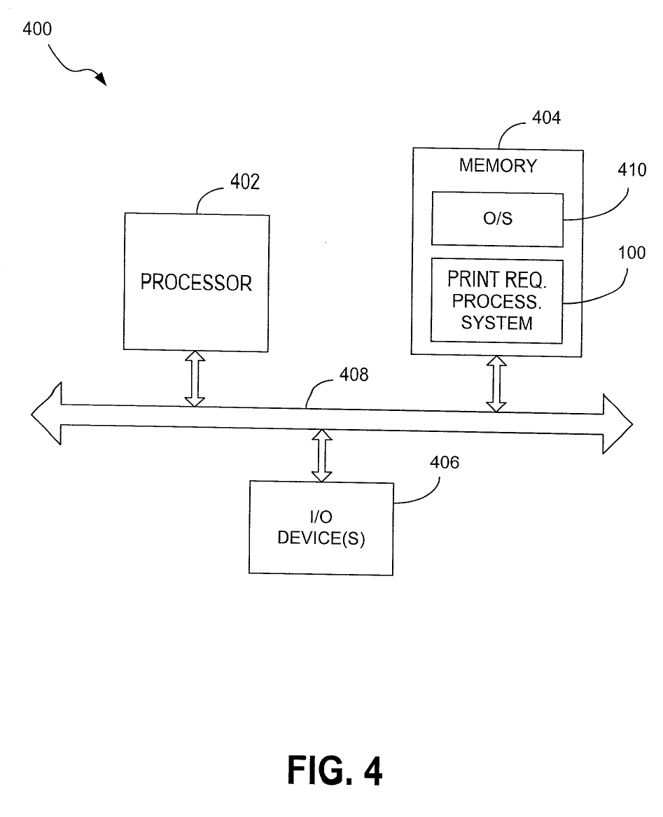

Print request processing system 100 can be implemented in software, firmware, hardware, or a combination thereof. When implemented in software, print request processing system 100 can be a program that is executable by a digital computer, an example of which is depicted schematically in FIG. 4.

Generally, in terms of hardware architecture, computer 400 of FIG. 4 includes a processor 402, memory 404, and one or more input and/or output (I/O) devices 406 (or peripherals) that are communicatively coupled via a local interface 408. Local interface 408 can be, for example, one or more buses or other wired or wireless connections, as is known in the art. Local interface 408 can include additional elements, which are omitted for ease of description. These additional elements can be controllers, buffers (caches), drivers, repeaters, and/or receivers, for example. Further, the local interface may include address, control, and/or data connections to enable appropriate communications among the components of computer 400.

Processor 402 can be a hardware device configured to execute software that can be stored in memory 404. Processor 402 can be any custom made or commercially available processor, a central processing unit (CPU) or an auxiliary processor among several processors. Additionally, the processor can be a semiconductor-based microprocessor (in the form of a microchip), for example.

Memory 404 can include any combination of volatile memory elements (e.g., random access memory (RAM, such as DRAM, SRAM, etc.)) and/or nonvolatile memory elements (e.g., ROM, hard drive, tape, CDROM, etc.). Moreover, memory 404 can incorporate electronic, magnetic, optical, and/or other types of storage media. Note that memory 304 can have a distributed architecture, where various components are situated remote from one another, but can be accessed by processor 402.

The software in memory 404 can include one or more separate programs, each of which comprises an ordered listing of executable instructions for implementing logical functions. The software in the memory 404 includes print request processing system 100 and a suitable operating system (O/S) 410. The operating system 410 controls the execution of other computer programs, such as print request processing system 100. Operating system 410 also can provide scheduling, input-output control, file and data management, memory management, and communication control and related services.

The I/O device(s) 406 can include input devices, such as a keypad and/or a receiver, for example. I/O device(s) 406 also can include output devices, such as a display device and/or a transmitter, for example. I/O device(s) 406 may further include devices that are configured to communicate both inputs and outputs, such as a network communication port, for example.

When the computer 400 is in operation, processor 402 is configured to execute software stored within the memory 404, communicate data to and from the memory 404, and generally control operations of the computer 400. Print request processing system 100 and the O/S 410, in whole or in part, are read by the processor 402, perhaps buffered within processor 402, and then executed.

When print request processing system 100 is implemented in software, it should be noted that the remote print system can be stored on any computer readable medium for use by or in connection with any computer-related system or method. In the context of this document, a computer-readable medium is an electronic, magnetic, optical, or other physical device or means that can contain or store a computer program for use by or in connection with a computer-related system or method. Print request processing system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

As used herein, a “computer-readable medium” can be any means that can store, communicate, propagate or transport a program for use by or in connection with an instruction execution system, apparatus, or device. Thus, a computer readable medium can be, for example but not limited to, an electronic, magnetic, optical, electromagnetic, infrared, or semiconductor system, apparatus, device, or propagation medium. More specific examples (a nonexhaustive list) of a computer-readable medium include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program could be electronically captured, via optical scanning of the paper or other medium, then compiled, interpreted or otherwise processed in a suitable manner, if necessary, and then stored in a computer memory.

When implemented in hardware, print request processing system 100 can be implemented with any or a combination of various technologies. By way of example, the following technologies, which are each well known in the art, can be used: a discrete logic circuit(s) having logic gates for implementing logic functions upon data signals, an application specific integrated circuit (ASIC) having appropriate combinational logic gates, a programmable gate array(s) (PGA), and a field programmable gate array (FPGA).

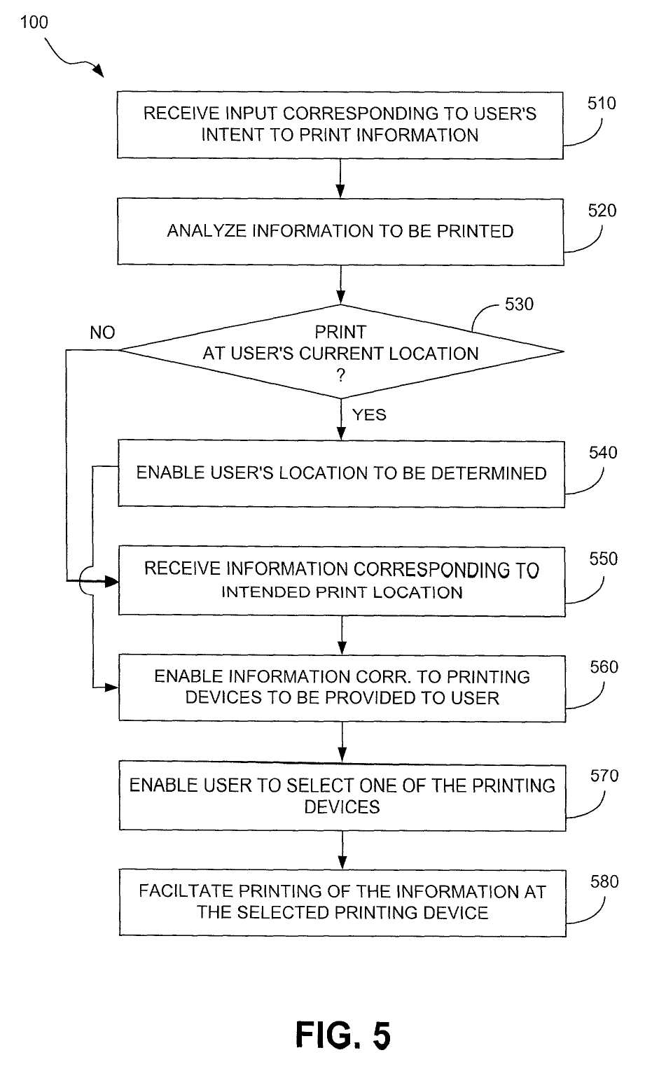

Reference will now be made to the flowchart of FIG. 5, which depicts the functionality of a representative embodiment of print request processing system 100. In this regard, each block of the flowchart represents a module segment or portion of code that comprises one or more executable instructions, or logic for implementing the specified logical function(s). It should also be noted that in some alternative implementations the functions noted in various blocks of FIG. 5, or any other of the accompanying flowcharts, may occur out of the order in which they are depicted. For example, two blocks shown in succession in FIG. 5 may, in fact, be executed substantially concurrently. In other embodiments, the blocks may sometimes be executed in the reverse order depending upon the functionality involved.

As shown in FIG. 5, print request processing system or method 100 may be construed as beginning at block 510, where information corresponding to a user's intent to print information is received. This information can include a designation of the information, i.e., the print task, that is to be printed. In block 520, the information to be printed is analyzed. More specifically, the information may be analyzed so as to determine one or more attributes of the information corresponding to particular print capabilities of printing devices. By way of example, the information may include color image data (an attribute), which corresponds to the ability of a printing device to produce color documents (a print capability). Various other attributes also could be analyzed, such as document type, e.g., PPT, DOC, PDF, TXT, etc., color complexity, e.g., photo, art, drawing, etc., among others.

In block 530, a determination is made as to whether the user desires printing of the information to be accomplished in the vicinity of the user's current location. If the user desires printing in the vicinity, the user's current location is determined (block 540). In some embodiments, this determination can be facilitated by a locating device, such as a GPS receiver, associated with the user. More specifically, in those embodiments where the user's intent to print information is facilitated by a mobile appliance, the mobile appliance may include such a locating device. Therefore, in block 540, determining the location of the user may include receiving information from such a locating device. Note, in some embodiments, determining the location of the mobile appliance may not be required. For instance, information corresponding to one or more printers pre-selected by the user, for example, can be provided based on an analysis of the information to be printed.

If, however, it is determined that the user does not intend to have the information printed at the user's location, information corresponding to a desired print location can be received from the user, such as depicted in block 550. For instance, the user may be in transit to a location where printed information is needed. If this were the case, determining the user's location to locate a suitable printing device could result in selection of printing devices a significant distance away from the user's destination.

In block 560, information corresponding to printing devices is enabled to be provided to the user. More specifically, the printing devices should be able to accommodate the attributes of the information to be printed and should be located in the vicinity of the user and/or the location where the user desires the printed information. In block 570, the user is enabled to select from among the identified printing devices and, thereafter, such as depicted in block 580, printing is facilitated at the selected printer.

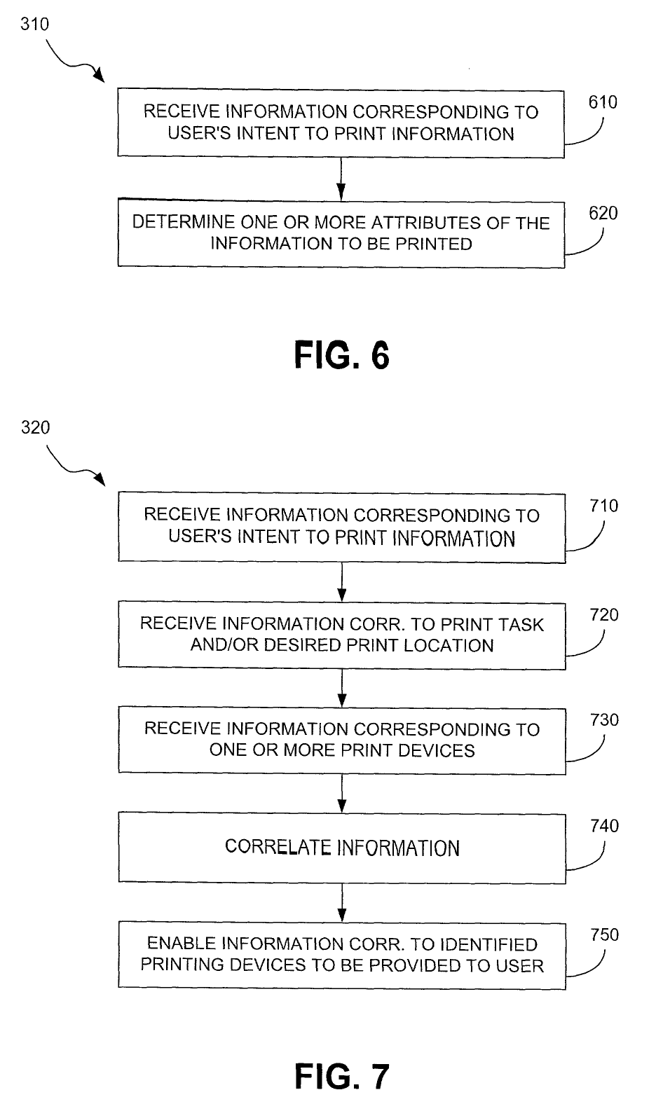

As mentioned before, the print request processing system may include a print analysis system 310 and/or a printing device selection system 320. The functionality of an embodiment of the print analysis system 310 is depicted in FIG. 6. The print analysis system or method 310 may be construed as beginning at block 610, where information corresponding to the user's intent to have information printed is received. This information can include a designation of the information to be printed. Thereafter, such as depicted in block 620, one or more attributes of the information to be printed are determined. Such attributes can include the presence/complexity of graphics, handout notes, preferred print medium size, number of pages, smallest/largest font size, document type, and duplex, among others. In some embodiments, information corresponding to the determined attributes may be stored for later use, such as by a printer selection system. Representative functioning of an embodiment of such a printing device selection system will now be described with reference to the flowchart of FIG. 7.

As shown in FIG. 7, the printing device selection system or method 320 may be construed as beginning at block 710, where information corresponding to the determined attributes of the print task is received. In block 720, information corresponding to the user's location and/or the desired print location is received. In block 730, information corresponding to one or more printing devices is received. In particular, the information can include the capabilities and/or the locations of multiple printing devices. In block 740, the information pertaining to the determined attributes of the print task and location for printing is correlated with the information pertaining to the capabilities and locations of the printing devices. This is done to identify those printing devices that are capable of processing the print task that also are properly located for printing the print task. Thereafter, such as depicted in block 750, the user is provided with information corresponding to the identified printing devices.

Information corresponding to the identified printing devices can be provided to a user by a print request system. Such a print request system is depicted in FIG. 3. In particular, the print request system 380 of FIG. 3 is associated with a mobile appliance, e.g., PDA 360. However, in other embodiments, such a print request system may not be associated with a mobile appliance. Regardless of the particular implementation, print request systems preferably are able to enable the user's intent to print information to be communicated to a print request processing system, as well as enable a user to select a printing device that is to be used for performing the printing.

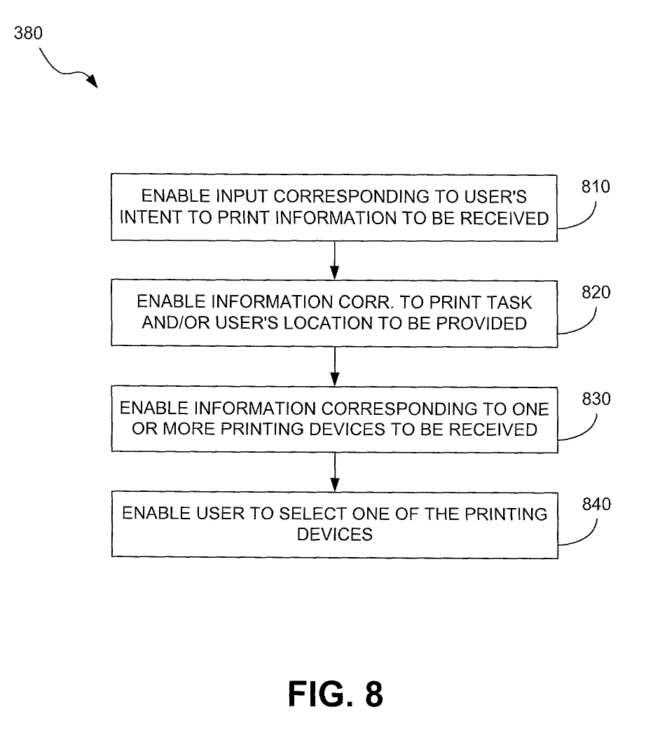

Print request systems can be implemented in hardware, firmware, software, or a combination thereof. The functionality of a representative embodiment of a print request system will now be described with reference to the flowchart of FIG. 8.

As shown in FIG. 8, the print request system or method 380 may be construed as beginning at block 810, where an input corresponding to the user's intent to print information is received. In block 820, information corresponding to the print task, as well as information corresponding to a location for printing the print task, is enabled to be provided. As mentioned before, the information corresponding to the location for printing can be the user's location and/or a location designated by the user. In block 830, information corresponding to one more printing devices is enabled to be received and provided to the user. For example, the information corresponding to the printing devices can be displayed to the user via a display device of the mobile appliance with which the print request system is associated. Thereafter, such as depicted in block 840, the user is enabled to select from among the printers. This can be accomplished by actuating a touch-screen icon associated with a particular one of the printing devices, for example. In some embodiments, once a particular printing device is selected and this information has been provided back to the print request processing system, the print request processing system can initiate the transfer of information to the selected printing device. This can include configuring the information so that the information can be appropriately processed by the printing device and/or establishing communication with the printing device.

Operation of representative embodiments of the print system will now be described with further reference to the schematic diagram of FIG. 3. In a first example, it is assumed that a user of mobile appliance 360 desires to print information associated with content 385. Note, content 385 is a associated with the mobile appliance. In order to begin the process of printing information corresponding to the content, the user may indicate a desire to have information printed by designating the content. This can be accomplished by selecting a file associated with the content, and then actuating a print icon associated with the mobile appliance, for example. In response to actuating the print icon, the user may be queried as to whether printing is desired at the user's current location or at another location designated by the user. Based on the response to the previous query, information corresponding to the desired print location can be sent to the print request processing system 100. In particular, the mobile appliance can communicate the information to the print request processing system via network 110.

Since the information to be printed resides on the mobile appliance, information corresponding to attributes of the information to be printed can be determined by either the print request system or the print request processing system. In those embodiments where the attributes are determined by the print request system, information corresponding to the determined attributes typically is provided to the print request processing system. The print request processing system then can use the information corresponding to the desired print location and the determined attributes to identify printing devices that can be used for performing the printing operation.

Once printing devices have been identified, information corresponding to these devices can then be communicated back to the print request system. A selection of printing devices then can be provided to the user, such as via a display device of the mobile appliance. The user then is able to select from among the printing devices. Information corresponding to a selected printing device then can be communicated to the print request processing system so that information useful for communicating with the selected printing device can be provided to the mobile appliance. Such information can include an IP address, for example. Note, information that can be used for establishing communication with a printing device can be provided to the print request system when the selection of printing devices is provided. However, based on various considerations, such as available memory of the mobile appliance, for example, this information may be withheld from the print request system until a particular selection of a printing device is made. Once information necessary for establishing communication with the selected printing device is received, the print request system can then establish communication with that printing device so that information that is to be printed can be communicated to the printing device.

As a second example, a user of a mobile appliance, such as phone 350, may desire to print information that is not associated with the phone. For instance, the user may desire to print information associated with content 390. Content 390 may be associated with the user's office computer network or may reside at any other address that is be accessible via a communication network. When the user desires to perform such printing, the user can provide an input to the print request processing system that indicates this desire. In some embodiments, this may include indicating a desire to print information, such as an email, which is provided to the user via the messaging function of the phone. However, an attachment to the email, which may actually reside on the user's computer network, may not be not stored on the mobile appliance. In such a scenario, the user may be able to initiate the print request processing system by actuating a print icon associated with the email. This action can provide information to the print request processing system that adequately identifies the attachment that the user desires to print.

Once the information is provided, the user then may be prompted to provide a desired location at which the printing is to occur. Such information also is provided to the print request processing system. As described before, the information received by the print request processing system can be used to identify printing devices that are both capable of performing the printing operation and appropriately located for use. Information corresponding to the identified printing devices then can be provided to the user via the phone.

Upon selecting a particular printing device, information corresponding to the selection can be returned to the print request processing system, which then forwards the information that is to be printed to the selected printing device. Preferably, the print request processing system, or a system associated therewith, properly configures the information that is to be printed for use by the printing device.

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated. All such modifications and variations, are within the scope of the invention as determined by the appended claims.

1. A method for printing information comprising:
receiving information corresponding to a user's intent to print a print task;
identifying at least one printing device possessing capabilities corresponding to attributes of the print task such that the at least one the printing device is able to print the print task optimally compared to at least another unidentified printing device,
enabling the user to select from among the identified printing devices; and
facilitating printing of the print task at the selected printing device to produce a printed document such that the printed document exhibits the attributes of the print task.

2. The method of claim 1, wherein identifying the at least one printing device comprises:
retrieving information corresponding to the print task; and
analyzing the information corresponding to the print task to identify at least one attribute of the print task.

3. The method of claim 1, wherein identifying at least one printing device comprises:
enabling a current location of the user to be identified; and
identifying at least one printing device located in a vicinity of the current location of the user; and
wherein enabling the user to select from among the identified printing devices comprises:
enabling the user to select from among the printing devices identified in the vicinity of the current location.

4. The method of claim 1, wherein identifying the at least one printing device comprises:
receiving information corresponding to an intended location where the print task is to be printed; and
identifying at least one printing device located in a vicinity of the intended location; and
wherein enabling tile user to select from among the identified printing devices comprises:
enabling the user to select from among the printing devices identified in the vicinity of the location.

5. The method of claim 1, wherein identifying at least one printing device comprises:
storing information corresponding to the at least one printing device such that the information indicates, of each of the printing devices, at least one of: a location, a communication address, and at least one printing capability.

6. The method of claim 1, wherein receiving information corresponding to a user's intent to print a print task comprises:
receiving the information from a mobile appliance, at least in part, via a wireless communication network.

7. The method of claim 6, wherein enabling the user to select from among the identified printing devices comprises:
communicating information corresponding to the identified printing devices to the user, at least in part, via a wireless communication network such that the user is provided with information corresponding to the identified printing devices via the mobile appliance.

8. The method of claim 7, wherein facilitating printing of the print task at the selected printing device comprises:
retrieving information corresponding to the print task; and
communicating the information corresponding to the print task to the selected printing device via a communication network.

9. The method of claim 7, wherein the communication network comprises the Internet.

10. A method for printing information comprising:
receiving information corresponding to printing devices;
storing the information corresponding to the printing devices;
receiving, via a communication network, information corresponding to a user's intent to print a print task;
analyzing information corresponding to the print task to identify at least one attribute of the print task;
identifying a printing device possessing capabilities corresponding to the at least one attribute of the print task such that the printing device is able to print the print task optimally compared to at least another unidentified printing device;
providing the user with information corresponding to the printing device identified via a communication network;
enabling the user to select the printing device for printing the print task; and
facilitating printing of the print task at the printing device selected to produce a printed document such that the printed document exhibits the attributes of the print task.

11. The method of claim 10, wherein facilitating printing of the print task at the printing device comprises:
providing information corresponding to the print task to the printing device via a communication network.

12. The method of claim 10, wherein identifying a printing device comprises:
enabling a current location of the user to be identified; and
identifying at least one printing device located in a vicinity of the current location of the user.

13. The method of claim 10, wherein receiving information corresponding to printing devices comprises:
receiving, in regard to each of the printing devices, information corresponding to at least one of: a location, a communication address, and at least one printing capability.

14. The method of, claim 10, wherein receiving information corresponding to a user's intent to print a print task comprises:
receiving the information from a mobile appliance, at least in part, via a wireless communication network.

15. A system for printing information comprising:
a print request processing system configured to communicatively couple with a communication network, the print request processing system being configured to:
receive information corresponding to a user's intent to print a print task;
identify at least one printing device possessing capabilities corresponding to attributes of the print task such that the at least one printing device is able to print the print task optimally compared to at least another unidentified device;
provide information corresponding to at least one printing device identified to the user via a communication network; and
provide information corresponding to the print task to a selected one of the printing devices via a communication network such that the selected one of the printing devices is enabled to produce a printed document, the printed document exhibiting the attributes of the print task.

16. The system of claim 15, wherein the print request processing system is further configured to analyze information corresponding to the print task to identify at least one attribute of the print task, the at least one attribute being selected from: the presence of graphics, complexity of graphics, handout notes, print medium size, number of pages, smallest font size, largest font size, document type and duplex.

17. The system of claim 15, further comprising:
means for analyzing information corresponding to the print task to identify at least one attribute of the print task.

18. The system of claim 15, wherein the print request processing system is further configured to receive information corresponding to a current location of the user and identify printing devices located in a vicinity of the current location of the user such that the information corresponding to the identified printing devices includes only the printing devices identified in the vicinity of the current location of the user.

19. The system of claim 15, wherein the print request processing system is further configured to receive information corresponding to an intended location where the print task is to be printed and identify printing devices located in a vicinity of the intended location such that the information corresponding to the identified printing devices includes only the printing devices identified in the vicinity of the intended location.

20. The system of claim 15, further comprising:
a server configured to communicatively couple to a communication network; and
wherein the print request processing system resides on the server.

21. The system of claim 15, further comprising:
a print request system configured to communicatively couple with the communication network, the print request system being configured to:
receive information corresponding to a user's intent to print a print task,
receive information corresponding to at least one printing device, the at least one printing device possessing capabilities corresponding to attributes of the print task such that the at least one printing device is able to print the print task optimally compared to at least another printing device;
enable the user to select from among the at least one printing device identified; and
provide information corresponding to the selected printing device to the communication network.

22. The system of claim 21, further comprising:
a mobile appliance configured to communicatively couple to a communication network via a wireless protocol, and
wherein the print request system resides on the mobile appliance.

23. The system of claim 22, wherein the mobile appliance includes a Global Positioning System (GPS) receiver, the GPS receiver being configured to provide information corresponding to a current location of the user for use by the print request system; and
wherein the print request system enables the information corresponding to the current location of the user to be provided to the print request processing system.

24. The system of claim 22, wherein the mobile appliance includes a display device, the display device being configured to display the identified printing devices to the user.

25. The system of claim 15, further comprising:
at least one printing device communicating with the print request processing system, the at least one printing device being configured to receive information corresponding to the print task from the print request processing system and print the print task.

26. A system for printing information comprising:
a mobile appliance having a print request system, a user input component, a display device, and an RF transmitter/receiver configured to communicatively couple with a communication network, the print request system being configured to:
receive, via the user input component, information corresponding to a user's intent to print a print task,
receive, via the RF transmitter/receiver and communication network, information corresponding to at least one printing device, the at least one printing device possessing capabilities corresponding to attributes of the print task such that the at least one printing device is able to print the print task optimally compared to at least another printing device;
enable the at least one printing device identified to be displayed to the user via the display device;
enable the user to select from among the at least one printing device identified; and
provide information corresponding to the selected printing device to the communication network via the RF transmitter/receiver.

27. The system of claim 26, wherein the mobile appliance includes a Global Positioning System (GPS) receiver, the GPS receiver being configured to provide information corresponding to a current location of the user for use by the print request system.
